(19) United States
(12) Patent Application Publication
(10) Pub. No.: US 2025/0229786 A1
(43) Pub. Date: Jul. 17, 2025

(54) CONTROL DEVICE AND COMPUTER-IMPLEMENTED METHOD FOR CONTROLLING AN AT LEAST PARTIALLY AUTOMATED VEHICLE

(71) Applicant: Robert Bosch GmbH, Stuttgart (DE)

(72) Inventors: Johannes Christian Mueller, Stuttgart (DE); Joram Berger, Heimsheim (DE); Markus Schuetz, Tuebingen (DE); Ralf Kohlhaas, Calw (DE)

(21) Appl. No.: 19/008,727

(22) Filed: Jan. 3, 2025

(30) Foreign Application Priority Data
Jan. 17, 2024 (DE) 10 2024 200 405.7

(51) Int. Cl. B60W 30/182; B60W 60/00

(52) U.S. Cl. CPC B60W 30/182; B60W 60/0015; B60W 2556/20

(57) ABSTRACT

A computer-implemented method for controlling a vehicle. The method includes: ascertaining which multiple modules from a plurality of modules of the vehicle are ready for use, wherein each module is assigned respective module-specific boundary conditions; using a representation of an environment of the vehicle, ascertaining behavior mode{s), each of which is assigned one or more of the multiple modules and a respective priority and each of which represents respective behavior-mode-specific boundary conditions; for each behavior mode, ascertaining respective control boundary conditions using the module-specific boundary conditions of the module(s) assigned to the behavior mode, and the behavior-mode-specific boundary conditions represented by them; using the control boundary conditions of a selected behavior mode and the one or more modules assigned to the selected behavior mode, generating control parameters for controlling the vehicle according to the selected behavior mode; and controlling the vehicle according to the control parameters.

### CROSS REFERENCE

The present application claims the benefit under 35 U.S.C. § 119 of German Patent Application No. DE 10 2024 200 405.7 filed on Jan. 17, 2024, which is expressly incorporated herein by reference in its entirety.

### BACKGROUND INFORMATION

At least partially automated vehicles may independently undertake driving tasks. It is therefore necessary for these vehicles to manage complex situations, which may sometimes change quickly and unexpectedly. For ensuring the safety of the occupants and other road users, it is also necessary for systems that independently undertake driving tasks to be highly safety-critical. In general, such a system may comprise a plurality of modules, each module being able to undertake at least part of a driving task. However, malfunctions may occur, causing individual modules to either become unreliable or fail altogether.

### SUMMARY

The present invention relates to a control device and a computer-implemented method for controlling an at least partially automated vehicle. According to various embodiments of the present invention, individual modules of a plurality of modules of the vehicle may be redundant so that other modules can replace failed modules in whole or in part. The method of the present invention described here makes it possible to manage the plurality of modules such that the system is resilient against the failure of individual modules. This is made possible by the system dynamically reconfiguring in the event of a fault (failure of one or more modules) so that other, ready-for-use modules take over the function of the failed module in whole or in part.

Various exemplary embodiments of the present invention are specified below.

Example 1 is a computer-implemented method for controlling an at least partially automated vehicle (for example according to one of levels L2 to L5), wherein the method comprises: ascertaining which multiple modules from a plurality of modules of the vehicle are ready for use (e.g., available and reliable), wherein each module of the plurality of modules is assigned respective module-specific boundary conditions; ascertaining a representation of an environment of the vehicle using at least one of the multiple modules and sensor data representing the environment of the vehicle and/or parameters of the vehicle; using the representation of the environment of the vehicle, ascertaining one or more behavior modes, each of which is assigned one or more of the multiple modules and a respective priority and each of which represents respective behavior-mode-specific boundary conditions (e.g., implicitly or explicitly); for each behavior mode, ascertaining respective control boundary conditions using the respective module-specific boundary conditions of the one or more modules assigned to the behavior mode, and the behavior-mode-specific boundary conditions represented by the behavior mode; selecting a behavior mode from the one or more behavior modes using their respective priorities; using the control boundary conditions of the selected behavior mode and the one or more modules assigned to the selected behavior mode, generating control parameters for controlling the vehicle according to the selected behavior mode; and optionally controlling the vehicle according to the control parameters.

Clearly, for the strategic planning of a behavior mode of the vehicle, only the ready-for-use modules are taken into account and the boundary conditions of the (selected) behavior mode to be performed are updated to the boundary conditions of the ready-for-use modules to be used for this purpose. Clearly, the strategic planning for ascertaining a behavior mode to be performed is carried out dynamically on the basis of the ready-for-use modules, which ensures a resilient configuration.

The phrase that an element, a parameter, etc. “represents” another element, another parameter, etc. may be understood to mean that they are linked together, e.g., the element and/or the parameter is a (e.g., unique, e.g., bijective) function of the other element and/or parameter.

Example 2 is configured according to example 1, wherein the plurality of modules comprises at least one module from the following group of modules: a perception module, a verification module, and/or a planning module.

Example 3 is configured according to example 1 or 2, wherein ascertaining the one or more behavior modes comprises: ascertaining the one or more behavior modes using multiple, at least partially predefined behavior modes (e.g., selecting from them or configuring them together via a tree structure), wherein each predefined behavior mode of the multiple predefined behavior modes is respectively assigned at least one module of the plurality of modules by means of which the predefined behavior mode may be performed.

Example 4 is configured according to one of examples 1 to 3, wherein the selected behavior mode is selected using vehicle-specific boundary conditions (e.g., kinematic boundary conditions, such as speed boundary conditions, acceleration boundary conditions, navigation comfort boundary conditions, etc.); and/or wherein each behavior mode comprises the respective behavior-mode-specific boundary conditions, or wherein the method furthermore comprises ascertaining the corresponding behavior-mode-specific boundary conditions on the basis of the behavior mode.

Example 5 is configured according to one of examples 1 to 4, wherein ascertaining which of the multiple modules from the plurality of modules of the vehicle are ready for use comprises: monitoring each module of the plurality of modules with regard to availability and functional reliability; ascertaining which modules of the plurality of modules are available; ascertaining which modules of the plurality of modules are functioning reliably; and ascertaining the modules that are available and functioning reliably (e.g., as the multiple modules).

This can ensure that only modules that are both available and functioning reliably are classified as ready-for-use.

Example 6 is configured according to example 5, furthermore comprising: for each module of the multiple modules, ascertaining a reliability level representing a probability of the availability of the module, and a reliability level representing a probability of the reliability of the module; and, for at least one module (e.g., each module) of the multiple modules, adjusting the module-specific boundary conditions using the availability level and/or the reliability level; or, for each module of the multiple modules, ascertaining a readiness level representing a probability of the availability and reliability of the module; and, for at least one module (e.g., each module) of the multiple modules, adjusting the module-specific boundary conditions using the readiness level.

In this way, the boundary conditions may be adjusted depending on the certainty with which a module is classified as ready-for-use (reliable and/or available). If a module is classified as ready-for-use, but with limited certainty, the boundary conditions of the module may be adjusted in order to increase the safety of the overall system.

Example 7 is a control device configured to perform the method according to one of examples 1 to 6.

Example 8 is a vehicle (e.g., an automated or autonomous vehicle, for example according to one of levels L2 to L5) comprising the control device according to example 7.

Example 9 is a computer program comprising instructions that, when executed by a processor, cause said processor to carry out a method according to one of examples 1 to 6.

Example 10 is a computer-readable medium which stores instructions that, when executed by a processor, cause said processor to carry out a method according to one of examples 1 to 6.

### BRIEF DESCRIPTION OF THE DRAWINGS

In the figures, like reference signs generally refer to the same parts throughout the different views. The drawings are not necessarily to scale, emphasis being instead generally placed on representing certain principles of the present invention. Various aspects are described in the following description with reference to the figures.

FIG. 1 shows a flowchart of a computer-implemented method for controlling an at least partially automated vehicle, according to an example embodiment of the present invention.

FIG. 2 shows an exemplary control device configured to perform the computer-implemented method for controlling the at least partially automated vehicle, according to an example embodiment of the present invention.

FIG. 3 shows an exemplary implementation of the computer-implemented method for controlling the at least partially automated vehicle, according to various embodiments of the present invention.

### DETAILED DESCRIPTION OF EXAMPLE EMBODIMENTS

The following detailed description relates to the accompanying drawings, which, for clarification, show specific details and aspects of this disclosure in which the present invention can be implemented. Other aspects can be used, and structural, logical, and electrical changes can be carried out without departing from the scope of protection of the present invention. The various aspects of this disclosure are not necessarily mutually exclusive since some aspects of this disclosure may be combined with one or more other aspects of this disclosure to form new aspects.

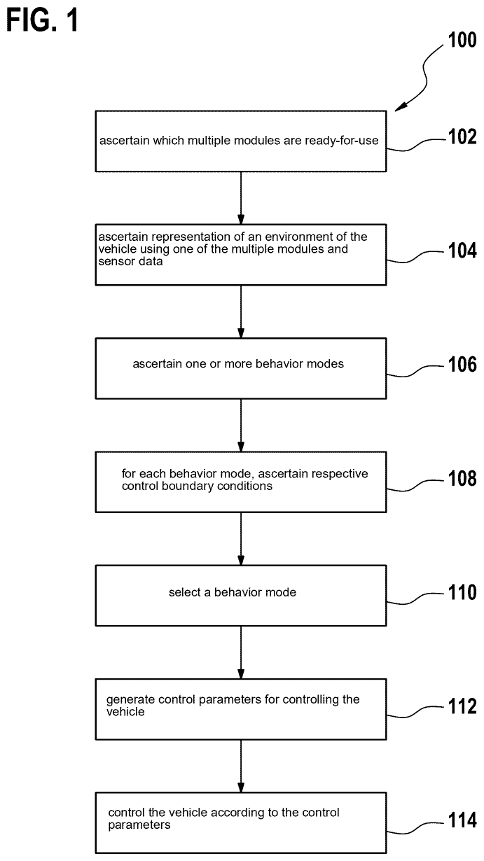

In summary, according to various embodiments of the present invention, a computer-implemented method 100 is provided, as illustrated in FIG. 1 and described in example 1.

The method 100 may (in 102) comprise ascertaining which multiple modules from a plurality of modules of the vehicle are ready-for-use (e.g., available and reliable). Here, each module of the plurality of modules may be assigned respective module-specific boundary conditions.

The method 100 may (in 104) comprise ascertaining a representation of an environment of the vehicle using at least one of the multiple modules and sensor data representing the environment of the vehicle and/or parameters of the vehicle.

The method 100 may (in 106) comprise ascertaining one or more behavior modes, each of which is assigned one or more of the multiple modules and a respective priority and each of which represents respective behavior-mode-specific boundary conditions (e.g., implicitly or explicitly), using the representation of the environment of the vehicle.

The method 100 may (in 108) comprise, for each behavior mode, ascertaining respective control boundary conditions using the respective module-specific boundary conditions of the one or more modules assigned to the behavior mode, and the behavior-mode-specific boundary conditions represented by the behavior mode.

The method 100 may (in 110) comprise selecting a behavior mode from the one or more behavior modes using their respective priorities.

The method 100 may (in 112) comprise, using the control boundary conditions of the selected behavior mode and the one or more modules assigned to the selected behavior mode, generating control parameters for controlling the vehicle according to the selected behavior mode.

The method 100 may optionally (in 114) comprise controlling the vehicle according to the control parameters.

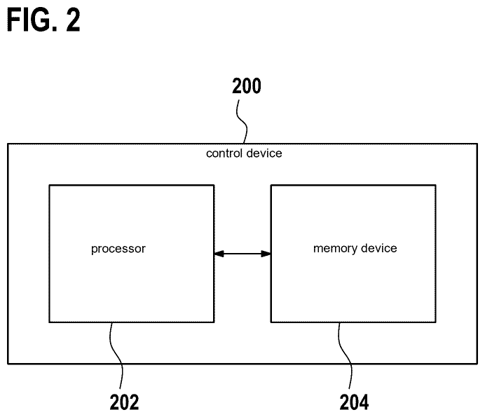

FIG. 2 shows an exemplary control device 200. The control device 200 may be configured to perform the method 100 described here. A “control device” as used here may be understood as any type of (e.g., logic-implementing) entity that permits the processing of data or signals. For example, the control device may comprise a circuitry and/or (at least) a processor (e.g., a processor 202), which may execute software stored in a memory device (in some aspects also referred to as a storage medium) (e.g., a memory device 204), in firmware, or in a combination thereof, and may issue instructions based thereon. A processor may comprise or be formed from an analog circuit, a digital circuit, a mixed-signal circuit, a logic circuit, a microprocessor, a central processing unit (CPU), a graphics processing unit (GPU), a digital signal processor (DSP), a programmable gate array (FPGA), an integrated circuit, or any combination thereof. Any other type of implementation of the corresponding functions described in detail here may also be understood as a processor or logic circuit. It is understood that one or more of the method steps described in detail here may be performed (e.g., implemented) by a processor. The processor may therefore be configured to carry out one of the methods described here, or its components, for information processing.

As explained here, an at least partially automated vehicle may comprise the control device 200. An at least partially automated vehicle may be an automated vehicle or an autonomous vehicle. For example, the at least partially automated vehicle may be a semi-automated vehicle (as per level 2), a highly automated vehicle (as per level 3), a fully automated vehicle (as per level 4), or an autonomous vehicle (as per level 5).

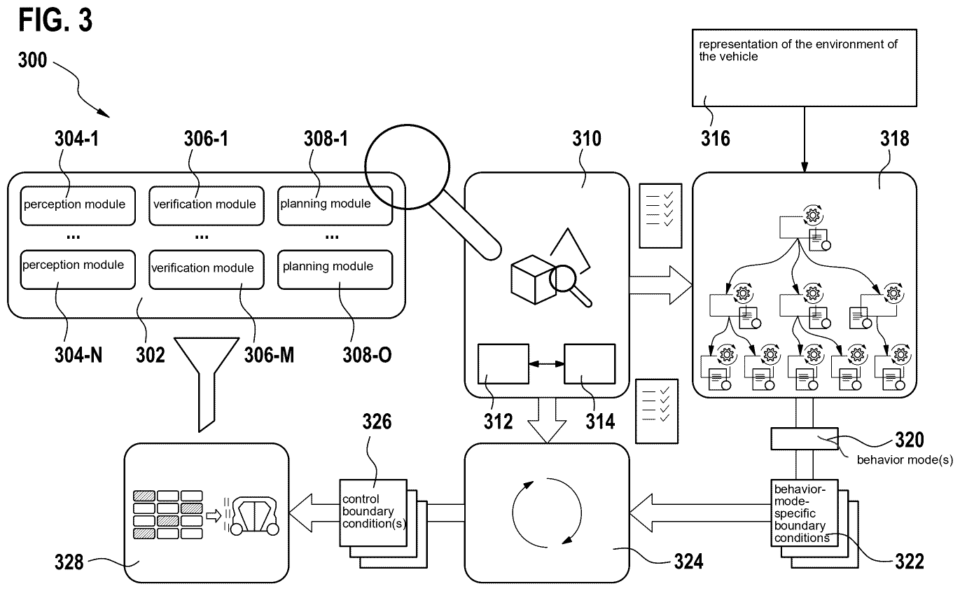

Various aspects of the method 100 are described in more detail below with reference to the modular system 300 shown in FIG. 3.

For example, a perception module may be configured to use sensor data to ascertain a representation of an environment of the vehicle and/or to recognize objects in the environment of the vehicle.

The system 300 may comprise a plurality of modules 302. For example, the plurality of modules 302 may comprise one or more perception modules 304-1 to 304-N (where N may be any integer greater than or equal to one). For example, a perception module may be configured to use sensor data to ascertain a representation 316 of an environment of the vehicle and/or to recognize objects in the environment of the vehicle. For example, the sensor data may comprise image data (e.g., camera data, video data, etc.), radar data, lidar data, ultrasonic data, etc. For example, the plurality of modules 302 may comprise one or more verification modules 306-1 to 306-M (where M may be any integer greater than or equal to one). A verification module may be configured to verify conditions with respect to the environment of the vehicle and/or parameters of the vehicle. For example, the plurality of modules 302 may comprise one or more planning modules 308-1 to 308-O (where O may be any integer greater than or equal to one). A planning module may be configured to plan a particular procedure (e.g., a driving trajectory) for a corresponding driving task on the basis of the representation of the environment of the vehicle and/or the recognized objects.

The system 300 may comprise a system monitor 310. The system monitor 310 may monitor the modules of the plurality of modules 302 and may assess their readiness for use. This may be carried out through self-diagnosis. A module may be ready-for-use if it is both available and operating reliably. A module may be available if it is online (i.e., operating). The system monitor 310 may assess the reliability of a module by means of a plausibility check and/or consistency check. For example, if a camera module and a lidar module recognize objects in the environment of the vehicle, but a radar module does not, this may indicate unreliability of the radar module (e.g., due to a malfunction of a radar sensor). For example, if a module generates a prediction for an event occurring in the future, and if the predictions of the module repeatedly do not come to pass, this may indicate unreliability of the module (e.g., due to a malfunction of a component).

Each module of the plurality of modules 302 may be assigned respective module-specific boundary conditions. The module-specific boundary conditions may specify for which partial situation the module may be used and under which limitations. In an illustrative example, a city lane-change module and a highway lane-change module may be used for the driving task of changing lanes. The city lane-change module may be assigned a maximum vehicle speed of 50 km/h in the city as a module-specific boundary condition, whereas the highway lane-change module may be assigned a greater maximum vehicle speed as a module-specific boundary condition.

The system monitor 310 may ascertain which multiple modules 312 of the plurality of modules 302 of the vehicle are ready for use. Optionally, for each module of the multiple modules 312, the system monitor 310 may ascertain an availability level representing a probability of the availability of the module, and/or a reliability level representing a probability of the reliability of the module. The system monitor 310 may be configured to adjust the module-specific boundary conditions of each module using the availability level and/or the reliability level. A module may be classified as reliable if the probability of the reliability is greater than or equal to a predefined reliability threshold value. The module-specific boundary conditions may be adjusted depending on the magnitude of the distance between the probability represented by the reliability level and the predefined reliability threshold value. For example, the maximum vehicle speed may be reduced. This applies analogously to the availability.

A probability described here has an assigned probability value. When a probability is compared to another probability or a threshold value here (e.g., greater than, less than, higher, lower, above, below, etc.), this refers to the probability value assigned to the probability.

The system 300 may comprise a strategic planner 318. The strategic planner 318 may ascertain one or more behavior modes 320 (e.g., a list of behavior modes) using the representation 316 of the environment of the vehicle. Each behavior mode may be assigned one or more modules of the (ready-for-use) multiple modules 312 and a respective priority. Clearly, the strategic planner 318 may generate a prioritized list of behavior modes 320. The strategic planner 318 may thus clearly specify how the system is to behave.

Each behavior mode may represent respective behavior-mode-specific boundary conditions 322 (e.g., implicitly or explicitly). In an example, the behavior mode may explicitly comprise the respective behavior-mode-specific boundary conditions 322 (e.g., be specified by them). Clearly, a behavior mode may be formulated as a set of the behavior-mode-specific boundary conditions 322 (and thus specify what is permitted as part of the behavior mode and what is not, what is to be done specifically, etc.). In another example, the behavior mode may implicitly specify the behavior-mode-specific boundary conditions 322, and the behavior-mode-specific boundary conditions 322 may be ascertained on the basis of the behavior mode.

Each behavior mode may be assigned one or more modules required for the behavior mode and for performing the underlying behaviors. If a behavior cannot be implemented by the ready-for-use, multiple modules 312, it is invalid and is not forwarded for execution. Clearly, the one or more behavior modes 320 relate to one or more valid behaviors.

The strategic planner 318 may ascertain the one or more behavior modes 320 using multiple, at least partially predefined behavior modes. In an example, the strategic planner 318 may select the one or more behavior modes 320 from the multiple, at least partially predefined behavior modes. In another example, the strategic planner 318 may configure the one or more behavior modes 320 together via a tree structure. In a tree structure, individual nodes may model partial situations and may each add additional boundary conditions to the behavior mode or adjust existing boundary conditions. This achieves scalability in open-world problems, for example.

As explained above, each behavior mode 320 may represent behavior-mode-specific boundary conditions 322, and each behavior mode 320 may require one or more modules of the ready-for-use, multiple modules 312. Here, each module 312 may comprise respective module-specific boundary conditions 314.

In 324, for each behavior mode 320, respective control boundary conditions 326 may be ascertained by adjusting the behavior-mode-specific boundary conditions 322 for the respective behavior mode 320 to the corresponding module-specific boundary conditions of the one or more modules assigned to the behavior mode. If module-specific boundary conditions are already present in the behavior-mode-specific boundary conditions, the behavior-mode-specific boundary conditions can be adjusted (provided that the module-specific boundary conditions are tighter). If module-specific boundary conditions are not present in the behavior-mode-specific boundary conditions, they may be added. Optionally, the strategic planner 318 may be configured to ascertain the control boundary conditions 326.

For example, with respect to the above-explained illustrative example of changing lanes, the system monitor 310 may ascertain that the highway lane-change module is not ready-for-use (e.g., not available and/or not reliable), but the city lane-change module is ready-for-use. The strategic planner 318 may ascertain a lane change at a construction site on a highway as a behavior (represented by a behavior mode 320). A maximum speed of 60 km/h may be specified at the construction site, and the behavior mode may therefore comprise the maximum speed of 60 km/h as a behavior-mode-specific boundary condition 322. Since the highway lane-change module is not ready-for-use (and thus not part of the multiple modules 312), the strategic planner 318 may assign the city lane-change module to the behavior mode 320; however, the city lane-change module is assigned a maximum vehicle speed of 50 km/h as a module-specific boundary condition. When ascertaining the control boundary conditions 326 (in 324), the boundary condition of the maximum vehicle speed may therefore be adjusted to 50 km/h.

In 328, a solution may then be found by selecting a behavior mode of the one or more behavior modes 320 according to their priorities. The behavior mode may be selected using vehicle-specific boundary conditions (e.g., kinematic boundary conditions, such as speed boundary conditions, acceleration boundary conditions, navigation comfort boundary conditions, etc.). For example, finding the solution may comprise a driving trajectory (e.g., a sequence of spatial-temporal conditions in a collision-free space) (e.g., a driving trajectory for a lane change).

Subsequently, control parameters may then be generated in order to control the vehicle according to the selected behavior mode while observing the control boundary conditions 326. With respect to the described illustrative example of changing lanes, the construction site on the highway may be traversed using the city lane-change module at a maximum speed of 50 km/h.

Even if the functions are limited by another module due to tighter module-specific boundary conditions, a function failure is reduced (e.g., prevented) according to the method 100 described here.

Clearly, with the method 100 described here (as opposed to conventional multi-path architectures), it is not necessary to specify redundant paths explicitly at design time, but rather a redundant, dynamic configuration is carried out at run time on the basis of the current situation. In this way, faults that are not predictable or predicted at design time may also be compensated. In comparison to the conventional approaches, the method 100 is also resilient against multiple, concurrently occurring faults. According to various embodiments, however, additional redundant paths may be generated when ascertaining the behavior mode by configuring a tree structure. In this way, the redundant paths provide additional protection. In general, the safety of the system is increased by the method 100 in that a significantly greater number of redundancies is generated.

What is claimed is:

1. A computer-implemented method for controlling an at least partially automated vehicle, the method comprising the following steps:
ascertaining which multiple modules from a plurality of modules of the vehicle are ready for use, wherein each module of the plurality of modules is assigned respective module-specific boundary conditions;
ascertaining a representation of an environment of the vehicle using at least one of the multiple modules and sensor data representing the environment of the vehicle and/or parameters of the vehicle;
using the representation of the environment of the vehicle, ascertaining one or more behavior modes, each of which is assigned one or more of the multiple modules and a respective priority and each of which represents respective behavior-mode-specific boundary conditions;
for each behavior mode, ascertaining respective control boundary conditions using the respective module-specific boundary conditions of the one or more modules assigned to the behavior mode, and the behavior-mode-specific boundary conditions represented by the behavior mode;
selecting a behavior mode from the one or more behavior modes using their respective priorities; and
using the control boundary conditions of the selected behavior mode and the one or more modules assigned to the selected behavior mode, generating control parameters for controlling the vehicle according to the selected behavior mode.

2. The method according to claim 1, wherein the plurality of modules includes at least one module from the following group of modules: a perception module, and/or a verification module, and/or a planning module.

3. The method according to claim 1, wherein the ascertaining of the one or more behavior modes includes: ascertaining the one or more behavior modes using multiple, at least partially predefined behavior modes, wherein each predefined behavior mode of the multiple predefined behavior modes is respectively assigned at least one module of the plurality of modules via which the predefined behavior mode may be performed.

4. The method according to claim 1, wherein:
the selected behavior mode is selected using vehicle-specific boundary conditions; and/or
each behavior mode includes the respective behavior-mode-specific boundary conditions, or the method further includes ascertaining the corresponding behavior-mode-specific boundary conditions based on the behavior mode.

5. The method according to claim 1, wherein the ascertaining of which of the multiple modules of the plurality of modules of the vehicle are ready for use includes:
monitoring each module of the plurality of modules with regard to availability and functional reliability;
ascertaining which modules of the plurality of modules are available;
ascertaining which modules of the plurality of modules are functioning reliably; and
ascertaining the modules that are available and functioning reliably.

6. The method according to claim 5, further comprising:
for each module of the multiple modules, ascertaining an availability level representing a probability of the availability of the module, and a reliability level representing a probability of the reliability of the module; and, for at least one of the multiple modules, adjusting the module-specific boundary conditions using the availability level and/or the reliability level; or
for each module of the multiple modules, ascertaining a readiness level representing a probability of the availability and reliability of the module; and, for at least one of the multiple modules, adjusting the module-specific boundary conditions using the readiness level.

7. A control device configured to control an at least partially automated vehicle, the control device configured to:
ascertain which multiple modules from a plurality of modules of the vehicle are ready for use, wherein each module of the plurality of modules is assigned respective module-specific boundary conditions;
ascertain a representation of an environment of the vehicle using at least one of the multiple modules and sensor data representing the environment of the vehicle and/or parameters of the vehicle;
using the representation of the environment of the vehicle, ascertain one or more behavior modes, each of which is assigned one or more of the multiple modules and a respective priority and each of which represents respective behavior-mode-specific boundary conditions;
for each behavior mode, ascertain respective control boundary conditions using the respective module-specific boundary conditions of the one or more modules assigned to the behavior mode, and the behavior-mode-specific boundary conditions represented by the behavior mode;
select a behavior mode from the one or more behavior modes using their respective priorities; and
using the control boundary conditions of the selected behavior mode and the one or more modules assigned to the selected behavior mode, generate control parameters for controlling the vehicle according to the selected behavior mode.

8. A vehicle, comprising:
a control device configured to control the vehicle, the vehicle being at least partially automated vehicle, the control device configured to:
ascertain which multiple modules from a plurality of modules of the vehicle are ready for use, wherein each module of the plurality of modules is assigned respective module-specific boundary conditions;
ascertain a representation of an environment of the vehicle using at least one of the multiple modules and sensor data representing the environment of the vehicle and/or parameters of the vehicle;
using the representation of the environment of the vehicle, ascertain one or more behavior modes, each of which is assigned one or more of the multiple modules and a respective priority and each of which represents respective behavior-mode-specific boundary conditions;
for each behavior mode, ascertain respective control boundary conditions using the respective module-specific boundary conditions of the one or more modules assigned to the behavior mode, and the behavior-mode-specific boundary conditions represented by the behavior mode;
select a behavior mode from the one or more behavior modes using their respective priorities; and
using the control boundary conditions of the selected behavior mode and the one or more modules assigned to the selected behavior mode, generate control parameters for controlling the vehicle according to the selected behavior mode.

9. A non-transitory computer-readable medium which stores instructions for controlling an at least partially automated vehicle, the instructions, when executed by a computer, causing the computer to perform the following steps:
ascertaining which multiple modules from a plurality of modules of the vehicle are ready for use, wherein each module of the plurality of modules is assigned respective module-specific boundary conditions;
ascertaining a representation of an environment of the vehicle using at least one of the multiple modules and sensor data representing the environment of the vehicle and/or parameters of the vehicle;
using the representation of the environment of the vehicle, ascertaining one or more behavior modes, each of which is assigned one or more of the multiple modules and a respective priority and each of which represents respective behavior-mode-specific boundary conditions;
for each behavior mode, ascertaining respective control boundary conditions using the respective module-specific boundary conditions of the one or more modules assigned to the behavior mode, and the behavior-mode-specific boundary conditions represented by the behavior mode;
selecting a behavior mode from the one or more behavior modes using their respective priorities; and
using the control boundary conditions of the selected behavior mode and the one or more modules assigned to the selected behavior mode, generating control parameters for controlling the vehicle according to the selected behavior mode.
